(19) United States
(12) Patent Application Publication
(10) Pub. No.: US 2017/0361691 A1
(43) Pub. Date: Dec. 21, 2017

(54) PICKUP TRUCK BED COVERING SYSTEM

(71) Applicants: Steve Fuller, Kent, WA (US); Mark Little, Renton, WA (US); Richard Kaye, Auburn, WA (US)

(72) Inventors: Steve Fuller, Kent, WA (US); Mark Little, Renton, WA (US); Richard Kaye, Auburn, WA (US)

(21) Appl. No.: 15/183,550

(22) Filed: Jun. 15, 2016

(51) Int. Cl. B60J 7/14; B60J 7/19

(52) U.S. Cl. CPC B60J 7/141; B60J 7/198

(57) ABSTRACT

The present disclosure relates to a cover for protecting the contents of the bed of a pickup truck. In some examples, the cover is designed for use in any standard pickup truck without the need for after-market modifications to the truck. In some examples, the truck bed cover comprises a panel system that is easily installed using the existing stake holes of the truck. In some further examples, the cover includes ability to convert the panels to sidewalls to protect taller cargo. In still further examples, the cover includes retaining cables, support bars, moisture protection, and a locking mechanism.

### BACKGROUND

The present disclosure relates generally to pickup truck bed covers. In particular, pickup truck bed covers that do not require after-market modifications to the truck are described.

There are several type of truck bed covers (also known as Tonneau covers) that are used to protect items in the truck bed from rain, sun, wind, snow, and other harmful elements. They are also used to keep the bed contents in place and prevent them from falling out of the truck bed while the vehicle is in motion.

Known pickup truck bed covers are not entirely satisfactory for the range of applications in which they are employed. For example, existing pickup truck bed covers require drilling holes or otherwise modifying the bed of the pickup truck in order to ensure a proper fit. In addition, conventional pickup truck bed covers require bed contents that are no higher than the side panels of the pickup truck bed, which severely limits the type of cargo one can carry. Further, if one wishes to transport items that are taller than the side panels of the truck bed (such as garbage cans or landscaping materials) the user must use a separate side wall system that requires removal of the cover.

Thus, there exists a need for pickup truck bed covers that improve upon and advance the design of known pickup truck bed covers. What is needed is a truck bed covering system that does not require drilling holes or otherwise making after-market modifications to the truck. What is also needed is a truck bed covering system that is capable as functioning as a bed cover and as a side wall system according to the user's needs and the type of cargo being transported. Such a covering system should be easy to install, simple to use, and cheap to manufacture. Examples of a new and useful pickup truck bed covering system relevant to the needs existing in the field are discussed below.

The present disclosure is directed to a covering system for protecting the contents of the bed of a pickup truck. In some examples, the system is designed for use in any standard pickup truck without the need for after-market modifications to the truck. In some other examples, the system comprises a panels that are easily installed using the existing stake holes of the truck. In some further examples, the system includes ability to convert the panels to sidewalls to protect taller cargo. In still further examples, the covering system includes retaining cables, support bars, moisture protection, and a locking mechanism.

### BRIEF DESCRIPTION OF THE DRAWINGS

FIG. 1 is a perspective view of a pickup truck bed covering system according to an embodiment of the present invention.

FIG. 2 is a perspective view of a first example of the panels of a truck bed covering system according to the embodiment shown in FIG. 1.

FIG. 3 is a plan view of the truck bed covering system shown according to an embodiment of the present invention.

FIG. 4 is a perspective view of an exemplary pickup truck bed having stake holes for use with the embodiment of the invention shown in FIG. 1.

FIG. 5 is a plan view of an adjustable bar for use with the embodiment of the invention shown in FIG. 1.

FIG. 6 is a plan view of a retaining cable system for use with the embodiment of the invention shown in FIG. 1.

FIG. 7A is a perspective view of the cable retaining system according to the embodiment in FIG. 6.

FIG. 7B is a perspective view of a portion of the cable retaining system according to the embodiment in FIG. 7A.

FIG. 7C is an alternate view of the embodiment the invention shown in FIG. 7B.

FIG. 8 is a plan view of a plurality of stake hole assemblies for use with the embodiment of the invention shown in FIG. 1.

FIG. 9A is a perspective view of a stake a hole assembly for use with the embodiment of the invention shown in FIG. 1.

FIG. 9B illustrates an alternative embodiment of a stake a hole assembly for use with the embodiment of the invention shown in FIG. 1.

FIG. 10 is an exploded view of stake hole assembly for use with the embodiment of the invention shown in FIG. 1.

FIG. 11A is a perspective view of the covering system in a closed position and also a perspective view of a moisture preventing system for use with the embodiment of the invention shown in FIG. 1.

FIG. 11B is an alternative view of the moisture preventing system shown in FIG. 11A.

FIG. 12 is a perspective view of the preferred embodiment of the covering system for use with the embodiment of the invention shown in FIG. 1.

### DETAILED DESCRIPTION

The disclosed pickup truck bed covering system will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various pickup truck bed covers are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

The present invention functions to protect the contents of a pickup truck bed without the need for after-market modifications to the truck bed itself. It also has the capability of functioning as bed sidewalls to protect taller cargo. It comprises a two-panel system and a plurality of attachment assemblies that are designed to work within the existing stake holes of a pickup truck's bed. It also comprises adjustable bars and retaining cables to provide support for the panels when they are functioning as sidewalls.

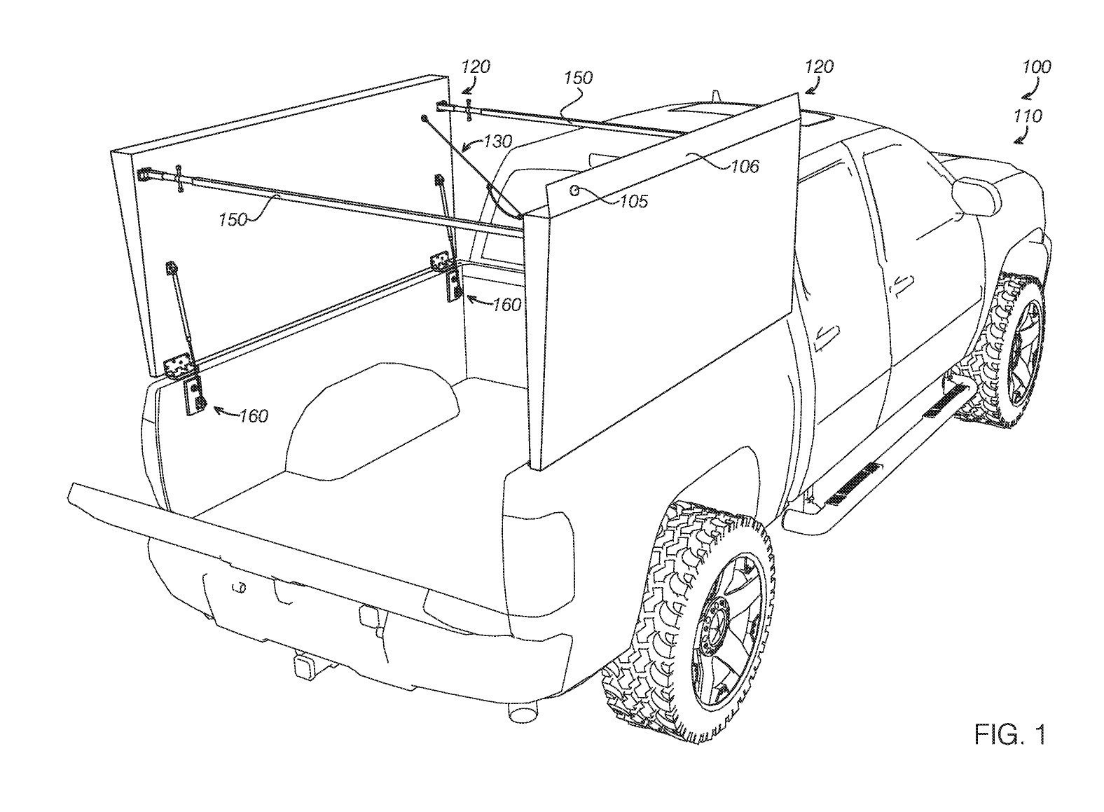

With reference to FIGS. 1-12, a first example of a pickup truck bed covering system, covering system 100, will now be described. Covering system 100 functions to protect the contents in the bed of a pickup truck. The reader will appreciate from the figures and description below that covering system 100 addresses shortcomings of conventional pickup truck bed covers. Covering system 100 works with the existing components of the bed 110 of a standard pickup truck and, as shown in FIG. 1, comprises a truck bed cover panel system 120, a rain guard 106, at least two adjustable bars 150, a retaining cable system 130, a locking mechanism 105, and a plurality of stake hole assemblies 160.

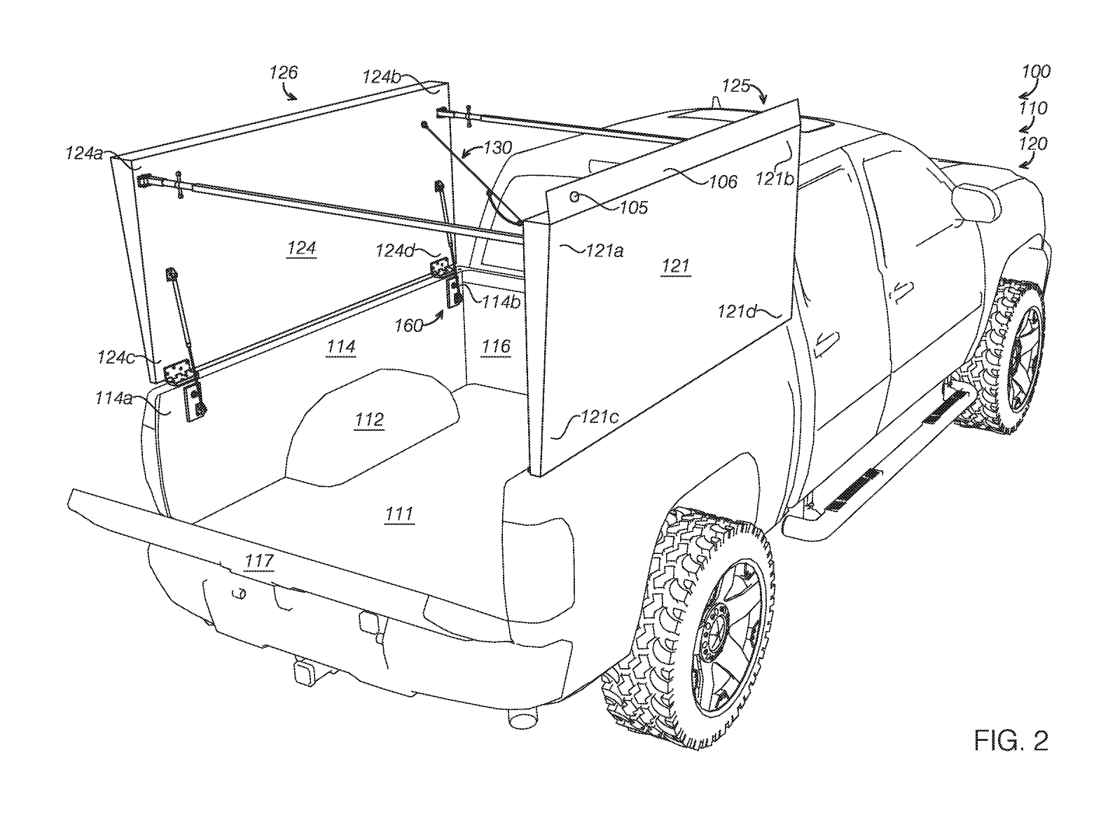

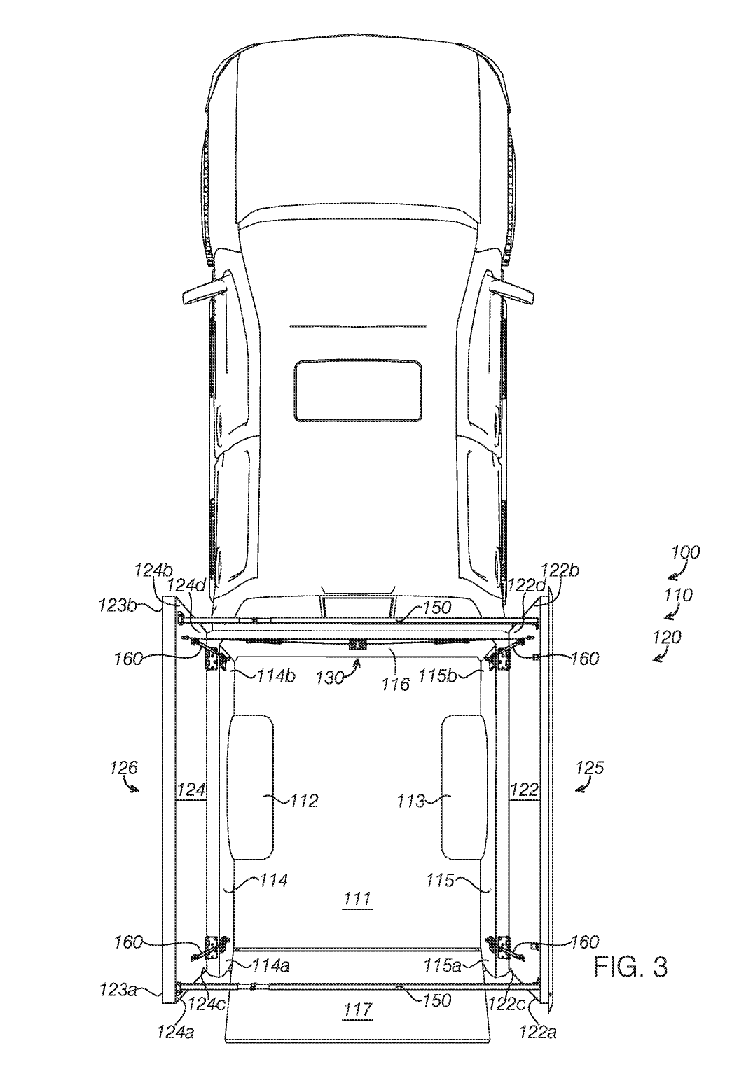

FIG. 2 is a perspective view of a first example of the pickup truck bed covering system according to an embodiment of the present invention and FIG. 3 is a plan view of covering system 100. As can be seen in FIGS. 2 and 3, and described in further detail in the following figures, truck bed cover panel system 120 further comprises a passenger side cover panel 125 comprising a passenger side cover panel outside 121 having a passenger side cover panel outside tailgate side top 121a, passenger side cover panel outside cab side top 121b, passenger side cover panel outside tailgate side bottom 121c, and a passenger side cover panel outside cab side bottom 121d. Similarly, truck bed cover panel system 120 further comprises a passenger side cover panel underside 122 (shown in FIG. 3), having a passenger side cover panel underside tailgate side top 122a, a passenger side cover panel underside cab side top 122b, a passenger side cover panel underside tailgate side bottom 122c, and a passenger side cover panel underside cab side bottom 122d.

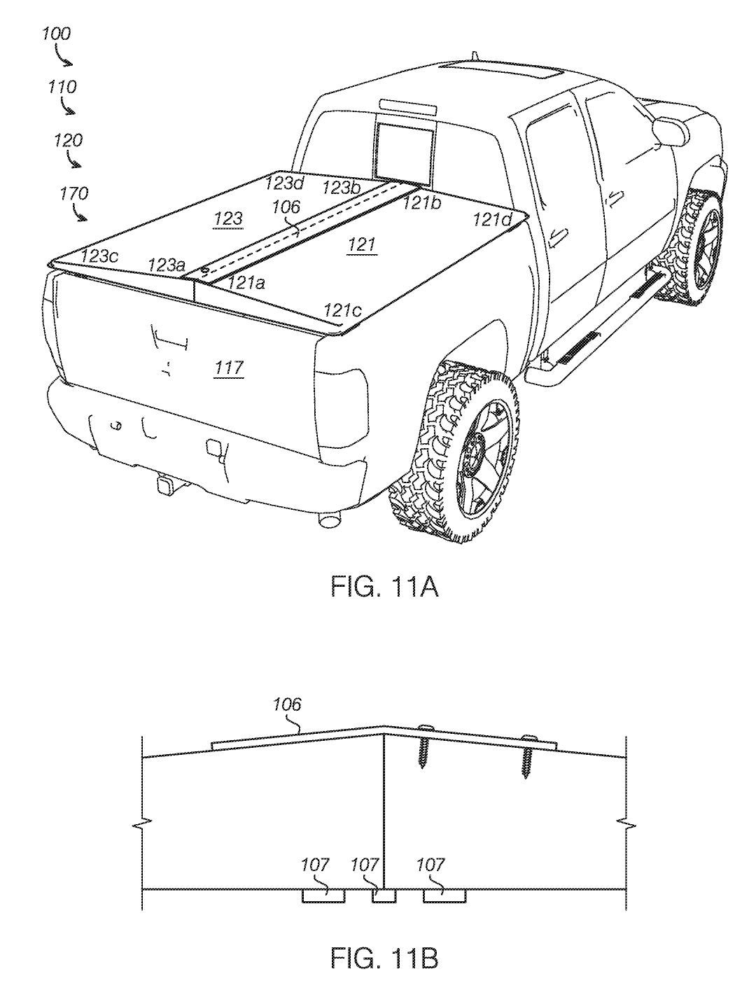

Truck bed cover panel system 120 also comprises a driver side cover panel 126 comprising a driver side cover panel outside 123 having a driver side cover panel outside tailgate side top 123a, a driver side cover panel outside cab side top 123b, a driver side cover panel outside tailgate side bottom 123c, and a driver side cover panel outside cab side bottom 123d (shown in FIG. 11). Finally, truck bed cover panel system 120 comprises a driver side cover panel underside 124 having a driver side cover panel underside tailgate side top 124a, a driver side cover panel underside cab side top 124b, a driver side cover panel underside tailgate side bottom 124c, and a driver side cover panel underside cab side bottom 124d.

As can be seen in FIGS. 2 and 3, pickup truck bed 110 includes a pickup truck bed floor 111, a pickup truck bed diver side wheel well 112, pickup truck bed passenger side wheel well 113 pickup truck bed driver side panel 114, a pickup truck bed passenger side panel 115, a pickup truck bed cab panel 116 having a cab panel middle 116a, and a pickup truck tailgate 117. Pickup truck bed driver side panel 114 comprises a driver side panel tailgate side top 114a and a driver side panel cab side top 114b. Similarly, pickup truck bed passenger side panel 115 comprises a passenger side panel tailgate side top 115a and a passenger side panel cab side top 115b.

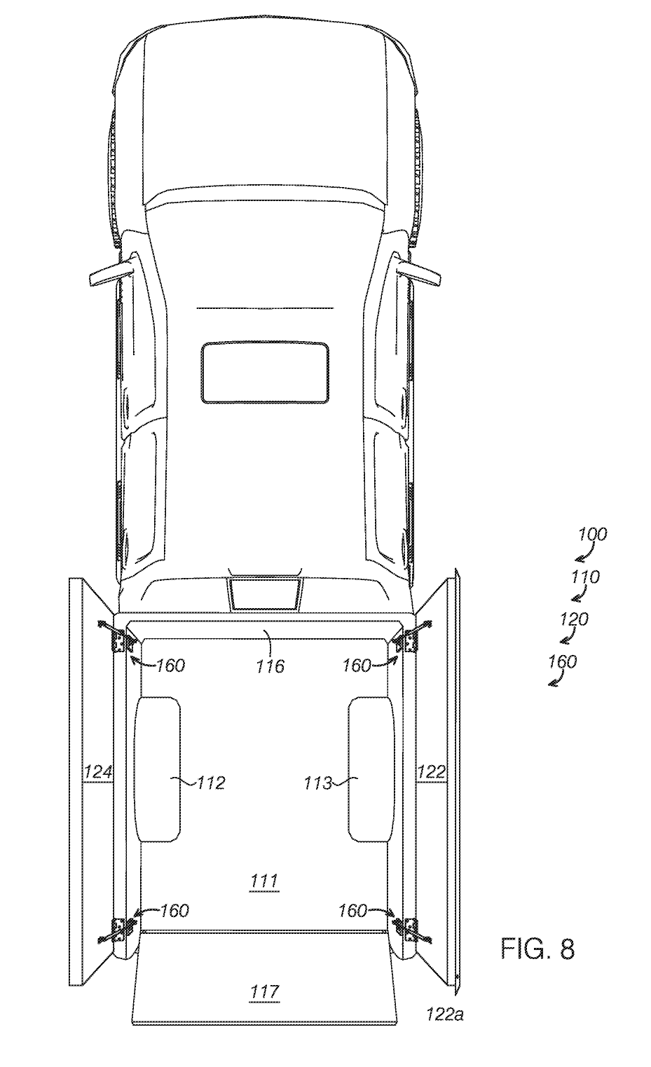

As can be seen in the plan view according to FIG. 3, the present embodiment of covering system 100 comprises an adjustable bar 150 positioned between passenger side cover panel underside cab side top 122b and driver side cover panel underside cab side top 124b and another adjustable bar 150 positioned between passenger side cover panel underside tailgate side top 122a driver side cover panel underside tailgate side top 124a. FIG. 3 also shows four stake hole assemblies 160 in each of four stake holes (described in further detail in FIG. 8). Finally, as can be seen, retaining cable system 130 is affixed to the middle of pickup truck tailgate middle 116 as shown.

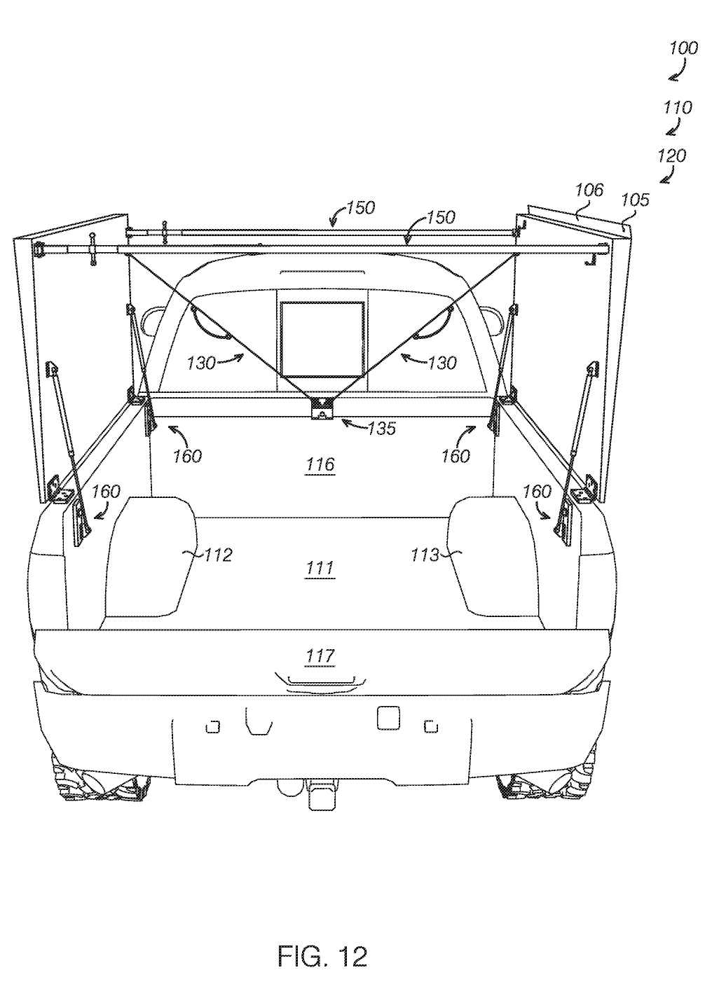

As mentioned above, it is an object of the present invention to function both as a truck bed cover and truck bed sidewalls. Thus, the reader will appreciate that, for the sake of simplicity, the present specification will refer to the system being in an “open” position when passenger side cover panel 125 and driver side cover panel 126 are substantially perpendicular to truck bed floor 111. When covering system 100 is in the open position, panel system 120 functions as sidewalls for protection of taller cargo. FIGS. 1, 2, 3, 5, 6 and 8 depict covering system 100 in the open position. Similarly, the present specification will refer to the system being in a “closed” position when passenger side cover panel 125 and driver side cover panel 126 are substantially parallel to truck bed floor 111. When covering system 100 is in the closed position, it functions to keep bed contents dry and acts as a cover. FIGS. 11 and 12 depict covering system in the closed position. Thus, in the open position, driver side cover panel 126 and passenger side cover panel 125 are substantially perpendicular to truck bed floor 111 and adjustable bar 150 may be positioned substantially between, and perpendicular to, driver side panel 114 and passenger side panel 115 as shown. In the closed position are substantially parallel to driver side panel 114 and passenger side panel 115 may be folded inward respectively such that they form a cover (discussed in further detail below).

Finally, the present figure shows tailgate 117 to be in a lowered position, however it should be understood that covering system 100 is designed to function with or without tailgate 117 and whether tailgate 117 is raised or lowered.

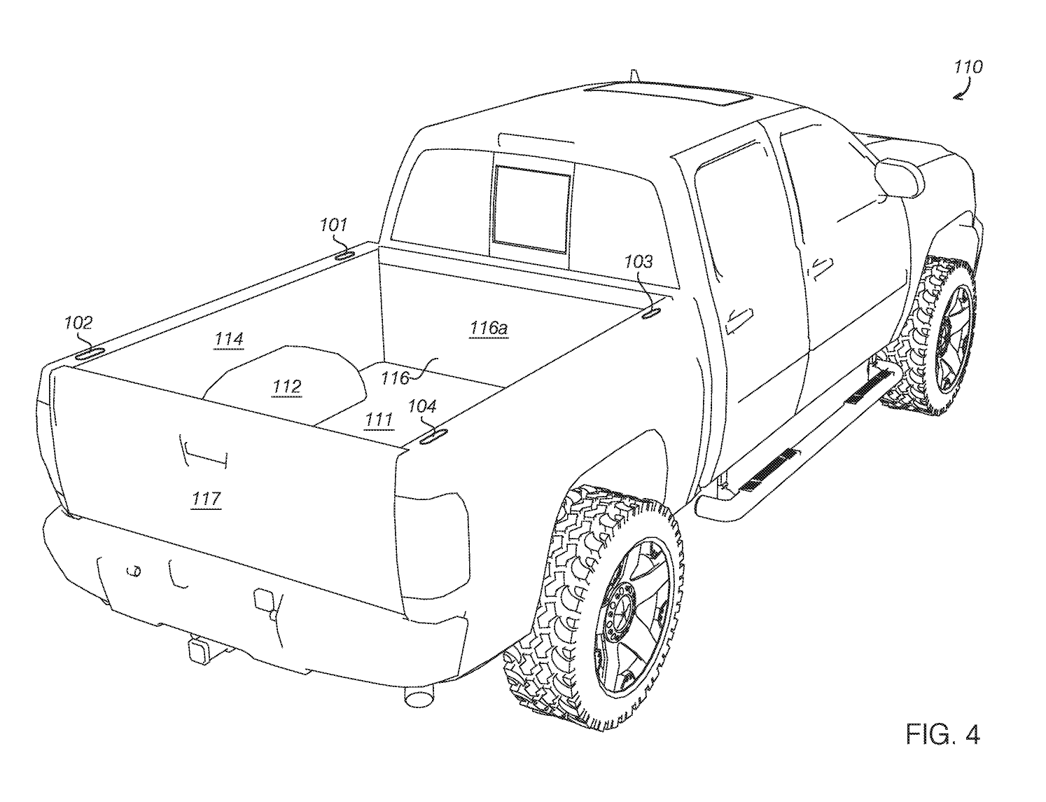

As mentioned above, covering system 100 is designed to work with the bed of a standard pickup truck. FIG. 4, then, is a perspective view of an exemplary pickup truck bed 110 for use with an embodiment of the invention shown in FIG. 1. Thus, in the present embodiment, pickup truck bed 110 comprises a driver side cab stake hole 101, a driver side tailgate stake hole 102, a passenger side cab stake hole 104, and a passenger side tailgate stake hole 104. It should be understood that it is an object of the present invention that covering system 100 is capable of being used in any standard pickup truck that is equipped with at least four stake holes.

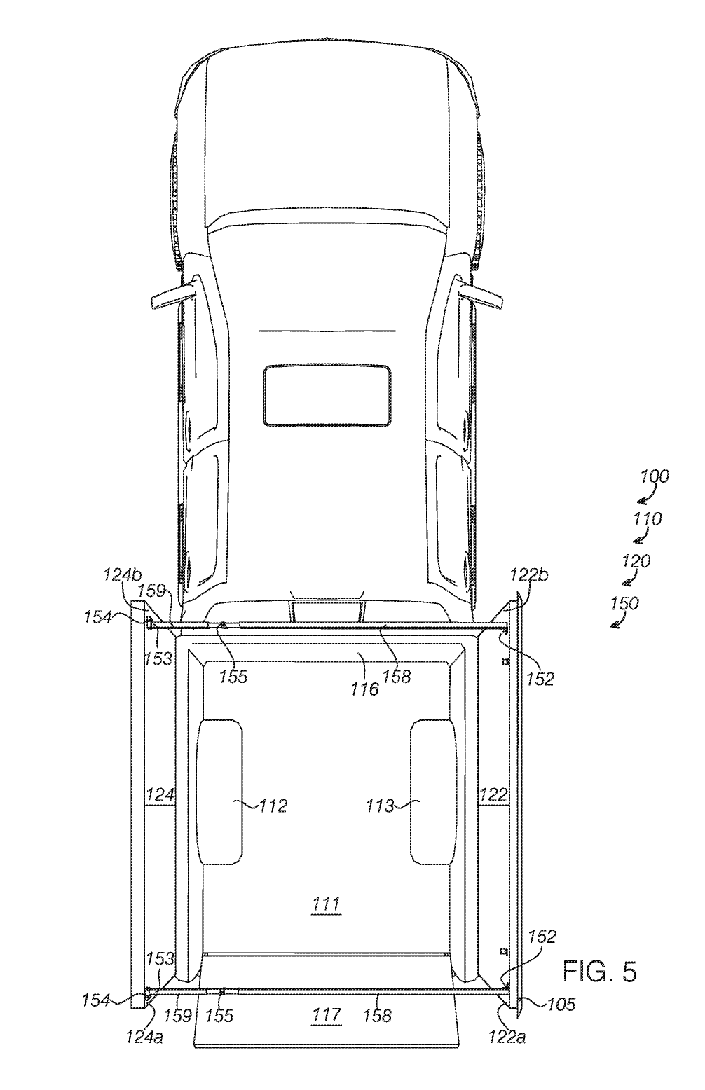

Referring now to FIG. 5, a plan view of adjustable bar 150 in use within covering system 100 is shown and described. When in use, adjustable bar 150 may function to provide additional support and to secure truck bed cover panel system 120 in an open position as shown. In the present embodiment, covering system 100 comprises two adjustable bar 150 by way of example only. It should be understood that the user may employ more or less adjustable bar 150 according to his or her specific needs. Thus, if the user wishes to employ a third or fourth adjustable bar 150 for additional stability of covering system 100 in the open position, he or she may do so by simply attaching additional adjustable bar 150 in a manner similar to that described below. Similarly, if the user wishes to use only one adjustable bar 150, he or she may do so by simply attaching the bar between the cab side or the passenger side of the panels (also discussed in further detail below).

In the embodiment according to FIG. 5, adjustable bar 150 comprises a pivoting means 152, a bar retaining means 153, a cover retaining means 154, a turning means 155, a pivoting means bar 158, and a retaining means bar 159. The reader will appreciate that the number of pivoting means 152 will always be equal to the number of retaining means 153 and the two structures will always be positioned on either end of adjustable bar 150 as shown. By way of example, the present figure shows one pivoting means 152 attached to passenger side cover underside cab side top 122b and a corresponding bar retaining means 153 attached to driver side panel cover underside cab side top 124b. Similarly, another pivoting means 152 is attached to passenger side cover panel underside tailgate side top 122a with a corresponding bar retaining means 153 attached to the driver side panel cover underside tailgate side top 124a. The reader will appreciate that it is an object of the present invention that the retaining and pivoting means may be attached to either side of the truck. Thus, in alternative embodiments, the user may attach pivoting means 152 to the driver side and the retaining means to the passenger side.

When the user wishes to employ adjustable bar 150, he or she will do so as follows: starting from the point where covering system 100 is in the closed position, the user will fold driver side cover panel 126 and passenger side cover panel 125 upward and outward via stake hole assembly 160 (described in further detail below) such that covering system 100 is in the open position. The user will then employ turning means 155 to extend adjustable bar 150 outward until retaining means bar 158 comes in contact with the opposite panel. In the embodiment according to FIG. 5, retaining means bar 158 comes into contact with driver side cover panel 126. It should be understood that, in alternative embodiments, adjustable bar 150 may be positioned such that retaining means bar 158 may be extended to passenger side cover panel 125. By way of example, in the present embodiment, adjustable bar 150 is an extendable threaded pole. It is an object of the present invention that other types of extendable poles may be employed such as telescoping and sliding poles and the like. In the present figure, two adjustable bar 150 are employed, both of which the user has turned turning mechanism 155 to extend retaining means bar 159 until it comes in contact with driver side or passenger side cover underside panel 124/122. The user will then engage cover retaining means 154 with bar retaining means 153. In this manner, the user may travel with covering system 100 in the open position thus employing covering system 100 as a sidewall system comprised of driver side cover panel 126 and passenger side cover panel 125.

In the present embodiment, bar retaining means 153 comprises a clip, however, it is an object of the present invention that bar retaining means 153 may be any mechanism sufficient to retain adjustable bar along the underside of a panel in a parallel position when not in use, such as ball and socket, clips, snaps, hook and loop, carabiners, and other suitable configurations. Further, in the present embodiment, pivoting means 152 is shown as a hinge and bar and cover retaining means (153, 154) is shown as a clip and ball joint configuration, however it should be understood that it is an object of the present invention to employ other retaining mechanisms such as friction fit, snap fit.

When not in use, (e.g., if the user does not wish to employ it or when covering system 100 is in the closed position), the user will place adjustable bar 150 in the non-use position as follows: Starting from the point where covering system 100 is in the open position, the user will disengage retaining means bar 158 from bar retaining means 153 and turn turning means 153 to retract retaining means bar 153 such that the length of adjustable bar 150 is reduced and is therefore no longer touching driver side cover panel 126. The user will then fold adjustable bar 150 inward via pivoting means 152 until pivoting means bar 157 comes to rest in a position that is substantially parallel to truck bed floor 111 when covering system 100 is in the closed position. Thus, when adjustable bar 150 is in the non-use position and covering system 100 is in the open position, adjustable bar will lie horizontally along the panel.

The reader will appreciate that, in alternative embodiments that contemplate two adjustable bar 150, the non-use position may also comprise opposing pivoting means 152 on a single panel, such that each adjustable bar 150 rests one above the other. It should be understood that the user may affix more than one adjustable bar to either panel. Thus, in this alternative embodiment, one pivoting means 152 may be affixed to, for example, the driver side panel cab side hinged at the back one hinged to driver side panel cab side top 114b and a second picoting means 152 may be affixed in a slightly lower position on driver side panel tailgate side top 114a. Finally, it is an object of the present invention that the user may employ one or more adjustable bar in any manner described above.

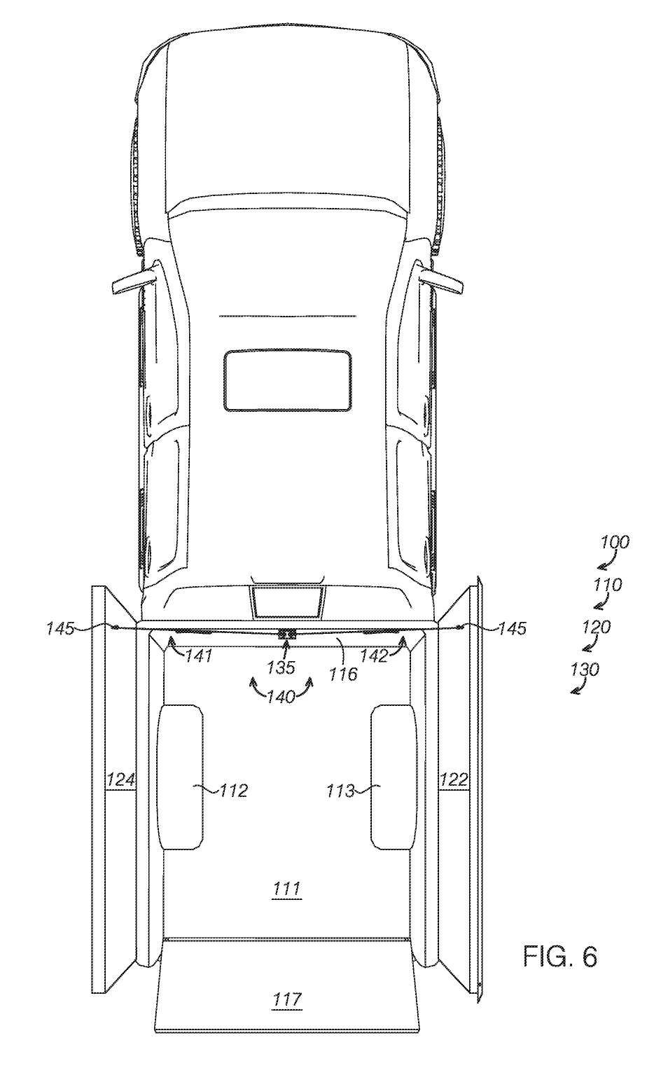

With reference now to FIG. 6, a plan view of retaining cable system 130 is shown and described. As can be seen, retaining cable system 130 comprises a center link 135, at least two panel attachment means 145 for coupling with cable panel 144, and at least two cable device 140. As can be seen, center link 135 is attached to cab panel 116 and is configured to receive cable device 140. In the present embodiment, cable device 140 comprises a driver side cable device 141 and a passenger side cable device 142. As can be seen, panel attachment means 145 is attached to the cover panel underside tops near the cab of the truck. Thus, in the present embodiment, a panel attachment means 145 is attached to driver side cover panel underside cab side top 124b and a second panel attachment means 145 is attached to passenger side cover panel underside cab side top 122b. Thus, driver side cable device 141 connects to the panel attachment means attached on the driver side and passenger side cable device 142 connects to the panel attachment means on the passenger side as shown.

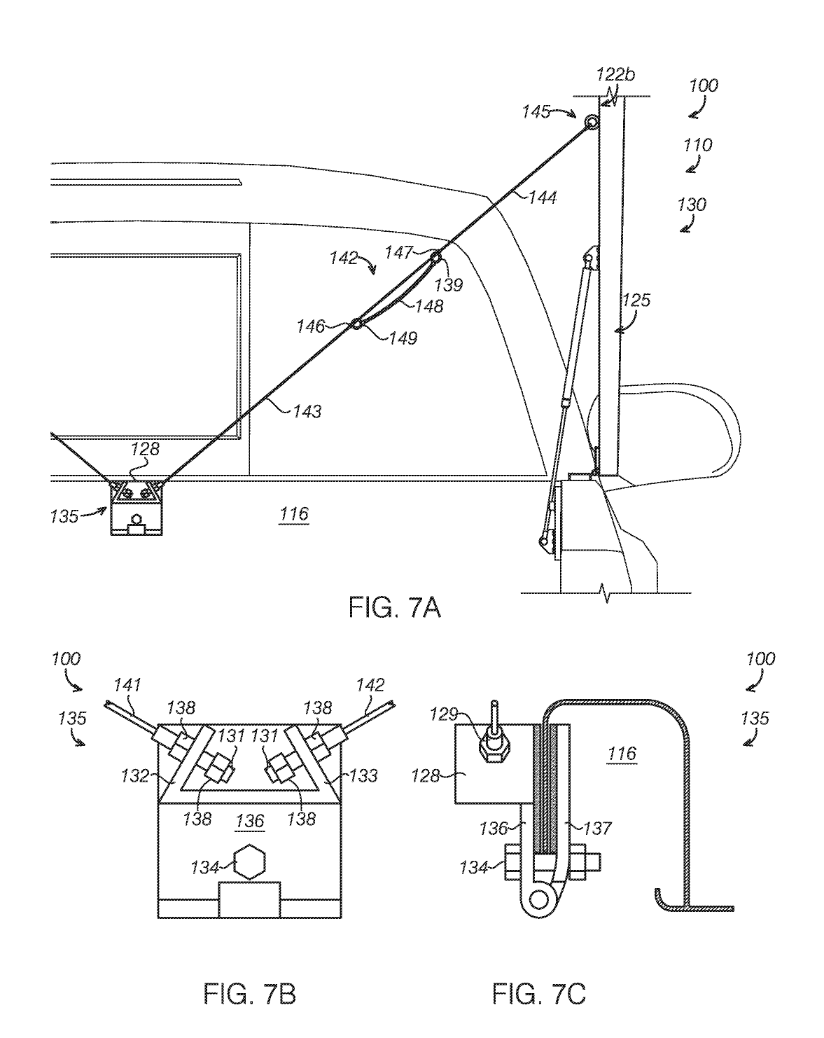

Referring now to FIGS. 7A-7C, 7A, alternative views of the components of retaining cable system 130 are shown. In the embodiment shown in FIG. 7A, an example of center link 135, passenger side cable device 142, and panel attachment means 145 is shown. FIG. 7B is a close-up view of center link 135 and FIG. 7C is a side view of center link 135. For the sake of brevity, the identical features of passenger side cable device 142 and driver side cable device 141 will not be redundantly explained. It should be understood that it is an object of the present invention that cable device 140 comprises passenger side cable device 142 and driver side cable device 141, which have identical features and work in tandem with the correlating cover panel to effectuate the purpose of retaining cable system 130, which is to provide support for covering system 100 in the open position and assist with keeping the panels from becoming over extended. Thus, though FIG. 7A depicts only to passenger side cable device 142, it should be understood that driver side cable device 141 works with driver side cover panel 126 in the same manner as described below.

As can be seen in FIG. 7A, cable device 140 further comprises a center link cable 143 having a center link cable anchor 131 (shown in FIG. 7B), a center link cable connector 146, a panel cable 144 having a panel cable anchor (not shown) and a panel cable connector 147. Cable device 140 further comprises cable joiner 148 having a center cable loop 149 and a panel cable loop 139. In the embodiment according to FIGS. 6 and 7A, and as shown in FIGS. 7B and 7C, center link 135 is fitted over cab panel 116 and secured via retaining cable system securing means 129 as shown. Also shown in FIGS. 7B and 7C, center link 135 further comprises a driver side cable receptor 132, a passenger side cable receptor 133, a center link securing means 134, a center link front plate 136, a center link rear plate 137, a center link top plate 128, a retaining cable system securing means 129, and a pair of cable retainers 138. By way of example, FIG. 7A is an illustration of passenger side cable device 142, however as mentioned above, the components of cable device 140 are identical and function in the same manner whether panel cable 144 is attached to panel attachment means 145 on passenger side cover panel 125 or driver side cover panel 126.

Retaining cable system 130 functions when covering system 100 is in the open position as shown. It should be understood that it is an object of the present invention for the retaining cable system to provide additional support for driver side cover panel 126 and passenger side cover panel 125 when they are functioning as sidewalls. Thus, when in use, the user folds open the panels in the manner described in the preceding figures. In the present embodiment, the pair of cable retainers 138 each comprises a screw and nut configuration as shown. It should be understood that, in alternative embodiments, cable retainers may be any appropriate threaded or non-threaded fasteners such as rivets, anchors, bolts, and other suitable means to securely connect the cables to center link 135 in the manner shown.

Referring to FIG. 8, a plan view of stake hole assembly 160 is shown. In the present embodiment, the number of stake hole assembly 160 is four, however it should be understood that it is an object of the present invention to provide a number of stake hole assemblies 160 that is equal to the number of stake holes present within the user's pickup truck. Thus, the number of stake hole assemblies in any given covering system 100 may vary depending on the number of available stake holes and according to the user's needs. As previously mentioned in FIG. 3, the present embodiment includes a driver side cab stake hole 101, a driver side tailgate stake hole 102, a passenger side cab stake hole 103 and a passenger side tailgate stake hole 104. Thus the four stake hole assemblies 160 in the present embodiment correspond, and are removably inserted into, each of the four stake holes mentioned above. Thus, the components of stake hole assembly are not directed to a particular side of the pickup truck or the corresponding panel.

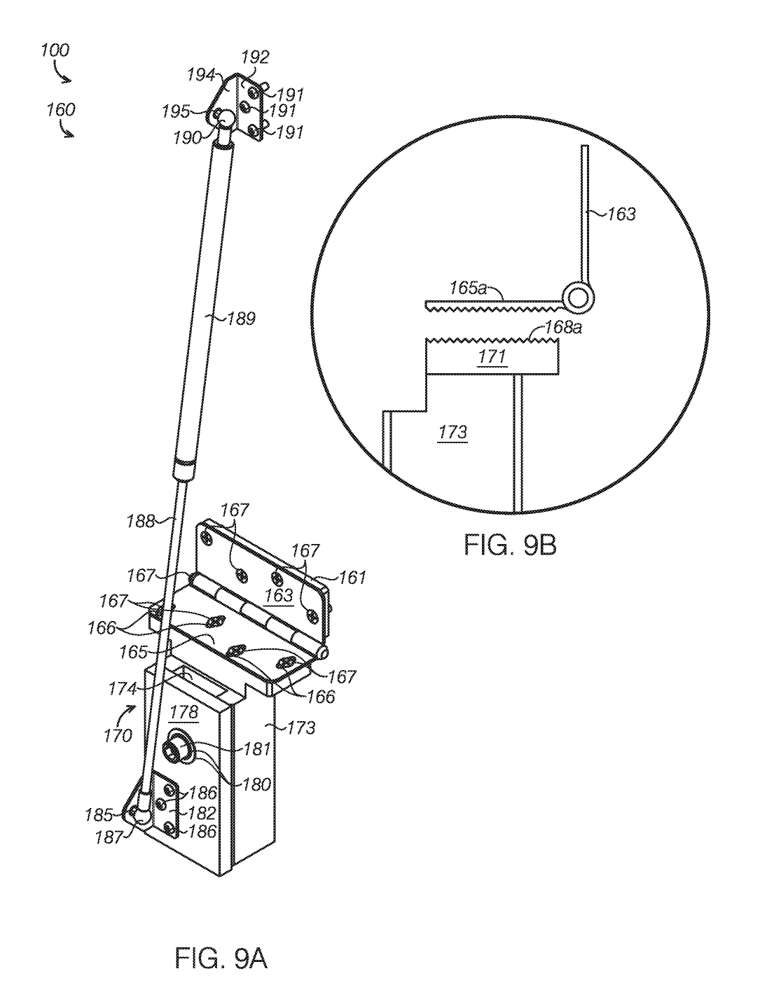

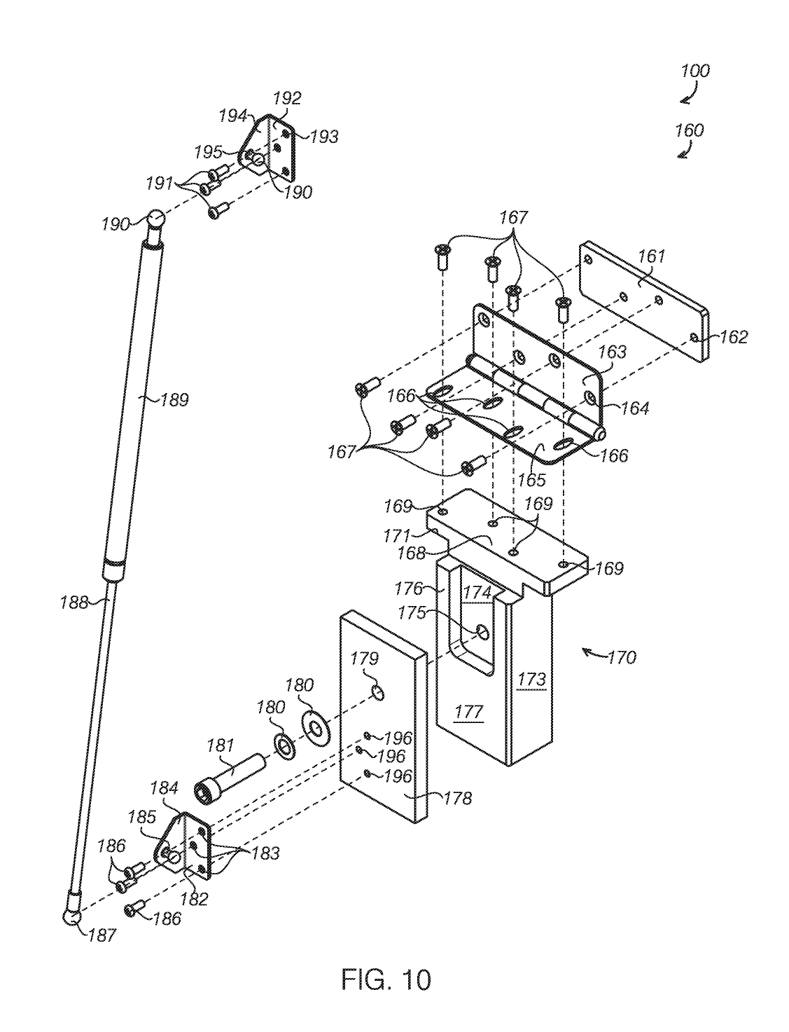

Referring now to FIGS. 9A and 9B, a perspective view of stake hole assembly 160 and an alternative embodiment thereof is shown. FIG. 10 is an exploded view of stake hole assembly 160. FIG. 9B illustrates an alternative embodiment of block assembly 170 comprising alternative block assembly leaf 165a and alternative block assembly top 168a. In this embodiment, alternative block assembly leaf 165a and alternative block assembly top 168a each have an increased surface area, thus increasing the security of the fit between the two. As shown in FIG. 9A, stake hole assembly 160 comprises a panel plate 161 having a panel plate aperture 162 a panel plate leaf 162, and a panel plate leaf aperture. Stake hole assembly 160 further comprises a block assembly 170 comprising a block assembly leaf 165 having a block assembly leaf aperture 166, a block assembly leaf fastener 167, and a block assembly top 168 having a plurality of block assembly top aperture 169.

Block assembly 170 further comprises a block assembly top platform 171, a block assembly side 173, a block assembly channel 174, a block assembly channel aperture 175, a block assembly groove 176, a block assembly front 177, a block assembly front plate 178, a block assembly front plate aperture 196, a block assembly front plate securer aperture 180, a pair of block assembly washers 180, a block assembly securer 181, a block assembly front plate leaf 182, and a block assembly front plate leaf aperture 183. Finally, stake hole assembly 160 also comprises a lift support bottom leaf 184, a lift support bottom leaf aperture 185, a block assembly front plate leaf fastener 186, lift support bottom 187, a lift support bottom extension 188, a lift support top 189, a lift support top 190, a lift support top panel leaf fastener 191, a lift support top panel leaf 192, a lift support top panel leaf aperture 193, a lift support top leaf 194, and a lift support top leaf aperture 196.

When in use, stake hole assembly 160 works within covering system to assist with lifting and keeping the panels to the open position. In order to install and use stake hole assembly 160, the user will employ one stake hole assembly 160 for each stake hole in the truck. Thus, the present embodiment utilizes four stake hole assemblies. Referring back to FIG. 9, then, the user will appreciate that, in the present embodiment, four stake hole assemblies 160 correspond, and are removably inserted into, each of the four stake holes mentioned above. Thus, FIG. 8 depicts a stake hole assembly in a driver side cab stake hole 101, a stake hole assembly in a driver side tailgate stake hole 102, a stake hole assembly in a passenger side cab stake hole 103, and a stake hole assembly in a passenger side tailgate stake hole 104. It should be understood that more or less stake hole assembly 160 may be used according to the user's needs and number of stake holes in the truck.

For the sake of brevity, the identical features of each stake hole assembly 160 will not be redundantly explained. It should be understood that it is an object of the present invention that the stake hole assemblies have identical features and work in tandem with the correlating cover panel to effectuate the purpose of stake hole assembly 160, which is to facilitate moving the panels into the open position. Thus, though FIGS. 9A and 10 depict only one stake hole assembly, FIG. 8 makes it clear that a plurality of assemblies work within covering system 100 in the same manner. Finally, as shown in FIG. 8, and read in conjunction with FIG. 4, each stake hole assembly is attached to the underside of a panel that corresponds to an individual stake hole. As can be seen in the present embodiment, a first stake hole assembly 160 is inserted into driver side cab stake hole 101 at attached near driver side cover panel underside cab side bottom 124d, a second stake hole assembly 160 is inserted into driver side tailgate stake hole 102 and attached near driver side cover panel underside tailgate side bottom 124c, a third stake hole assembly 160 is inserted into passenger side cab stake hole 103 and attached near passenger side cover panel underside cab side bottom 122d, and a fourth stake hole assembly 160 is inserted into passenger side tailgate stake hole 104 and attached near passenger side cover panel underside tailgate side bottom 122c.

Stake hole assembly 160 is assembled within and around a stake hole as follows: Lift support panel leaf 192 is positioned on the underside of a panel as mentioned above and secured using lift support top panel leaf fastener 191 and lift support top panel aperture 193. In the present embodiment, lift support top panel leaf fastener 191 is a threaded screw, however it is an embodiment of the present invention for other fasteners to be employed such as, for example, brads, nails, and the like. Lift support top 190 is retained within lift support top leaf 195 via lift support top leaf aperture 195 as shown. Lift support bottom extension 188 is connected to lift support bottom 187 and fits within lift support top extension 189, which is connected to lift support top 190. Finally, lift support bottom 187 is retained within lift support bottom leaf 184 via lift support bottom leaf aperture 185. In this manner, the lift support top, bottom, and their correlating extensions function to assist the user is raising and lowering the panel. In a preferred embodiment, covering system 100 utilizes a gas charged lift support, such as those known in the art.

Referring now to block assembly 170, as can be seen, block assembly front plate leaf 182 is positioned over block assembly front plate 178 and secured using block assembly plate lift fastener 186 and block assembly front plate leaf aperture 183. In the present embodiment, block assembly plate lift fastener 186 is a threaded screw, however it is an embodiment of the present invention for other fasteners to be employed such as, for example, brads, nails, and the like. It should be understood that it is an object of the present invention that the dimensions of block assembly front plate 178, block assembly side 173, and block assembly front 177 are slightly less, but commentary to, the dimensions of a standard pickup truck stake hole. Thus, stake hole assembly 160 is designed to be inserted to, and fit within, a stake hole as shown in the preceding figures.

After inserting block assembly 170 into a stake hole, the user will assemble the remaining components of stake hole assembly 160 as follows: block assembly front plate 178 (and therefore the attached components as discussed above) is positioned over the appropriate part of driver side or passenger side panel (114, 115) such that block assembly front plate securer aperture 179 aligns with block assembly channel aperture 175. Thus the appropriate portion of driver side truck panel 114 and passenger side truck panel 115 are placed substantially between block assembly 170 and block assembly front plate 178 as shown in the preceding figures. The user will then insert block assembly securer 181 into two block assembly washers 180 and through block assembly front plate securer aperture 179 and finally through block assembly channel aperture 175. The user will tighten block assembly securer 181, thus securing stake hole assembly 160 within and around a stake hole. In the present embodiment, block assembly securer 181 is a socket screw, however it is an object of the present invention that other types of fasteners, such as threaded screws, brads, nails, dowels, and the like are contemplated.

The embodiment according to FIG. 10 illustrates alternative block assembly top 168a and alternative block assembly leaf 165a, while the embodiment in FIG. 9 illustrates block assembly top 168 and block assembly leaf 165. As can be seen, block assembly 170 further comprises block assembly top platform 171, which supports either embodiment of the block assembly tops, both of which further comprise a plurality of block assembly top aperture 169. Depending on which embodiment the user prefers, block assembly leaf 165 is secured to block assembly top 168 or alternative block assembly leaf 165a is secured to alternative block assembly top 168a via a plurality of block assembly fasteners 167 that correspond to block assembly top aperture 168. Panel plate leaf 163 is secured to panel plate 161 by inserting block assembly fastener 167 into panel plate leaf aperture 163 and panel plate aperture 162 as shown. In the present embodiment, block assembly fastener 167 is a screw, however it is an object of the present invention that other types of fasteners, such as brads, nails, dowels, and the like are contemplated.

Panel plate 161 is secured to either driver side cover panel 126 or passenger side cover panel 125. Thus, when assembled, the plurality of stake hole assembly 160 allows the user to open and close the panels of covering system 100 in the manner described above. With the assistance of a plurality of stake hole assembly 160, the user may fold passenger side cover panel 125 upward and in a generally clockwise direction, and may close the same by folding downward and in a generally counter-clockwise direction. The user may open driver side cover panel 126 by folding it upward and in a generally counter-clockwise direction and may close the same by folding it downward and in a general clockwise direction. The reader will appreciate that it is an object of the present invention for the user to be able to attach and use covering system 100 without having to modify, drill holes, or otherwise damage the pickup truck bed floor 111 or any other component of pickup truck 110.

With attention to FIG. 11, a perspective view of covering system 100 in the closed position is shown and also includes a perspective view of a moisture preventing system according to an embodiment of the present invention. In the present embodiment, covering system 100 comprises a rain guard 106 and a locking mechanism 105. As can be seen, rain guard 106 traverses the length of passenger side cover panel 125 and driver side cover panel 126 and is positioned substantially over the portion where both panels join when covering system is in the closed position as shown. In this manner, rain guard 106 functions to prevent excess moisture from entering into pickup truck bed 110 and mitigates the potential for damage to the contents of pickup truck bed 110. In the present embodiment, rain guard 106 is attached to passenger side cover panel 125, however it is an object of the present invention that rain guard 106 may be attached to driver side cover panel 126.

Also shown in FIG. 11 is a rain gutter 108 having a pair of rain feet 107. As can be seen, rain gutter 108 is positioned between driver side cover panel underside 124 and passenger side cover panel underside 124 and one of the said pair of rain feet 107 on the driver side and the other of said pair of rain feet 107 on the passenger side. In this manner, any moisture that is not stopped by the rain guard will be caught by rain gutter 108 and rain feet 107. The user will appreciate that rain guard 106 and rain gutter 108 function when covering system 100 is in the closed position. In a preferred embodiment, rain guard 106, rain gutter 108, and rain feet 107 comprise a substantially water resistant material such as vinyl, rubber, nylon, polymers, and the like.

Finally referring to FIG. 12, a perspective view of the components of covering system 100 is shown. The reader will appreciate the components of covering system 100 work in concert to function as side walls or as a cover for a pickup truck according to the detailed descriptions in the preceding figures. As can be seen, the present figure depicts covering system 100 in the open position. Retaining cable system 130 is in use to keep truck bed cover panel system 120 in the open position and to prevent driver side cover panel 126 and passenger side cover panel 125 from over extending over the panels of the truck. One adjustable bar 150 is shown functioning to keep driver side cover panel 126 and passenger side cover panel 125 from falling down into the closed position. Finally, four stake hole assemblies 160 are shown inserted into each of four stake holes in pickup truck bed 110, whereby the panel system is closed or opened in the manner described above.

In alternative embodiments (not shown) covering system 100 may further comprise a seal that may be affixed to the driver side driver side panel 115, passenger side panel 114, and tailgate 117 such that it functions as an intermediate portion between the underside of each cover panel and the corresponding truck panel. In this manner, the seal provides for additional protection around the perimeter of the truck bed to prevent moisture and other damaging elements from affecting the contents of the truck bed while the vehicle is in motion.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A truck bed covering and sidewall system comprising:
two covers, each of the covers comprising:
a driver side cover comprising a top side, an underside, the underside having a first tailgate side, a second tailgate side, a first cab side, and a second cab side;
a passenger side cover comprising a top side, an underside, a first tailgate side, second tailgate side, a first cab side, and second cab side;
a retainer;
an adjustable bar having a driver side, driver side cover clip, a passenger side, a passenger side cover clip, and an extender;
an attachment assembly configured to removably insert into a stake hole;
a seal; and
a gas charged lift support having a top fastener and a bottom fastener.

2. The truck bed covering and sidewall system of claim 1, wherein:
a length of the driver side cover is approximately equal to a length of a driver side panel of a truck bed and a width of the driver side cover is approximately equal to one half the length of a tail gate of the truck bed;
the driver side cover first tailgate side is substantially adjacent to a back end stake hole of the driver side panel and the driver side second tailgate side is substantially adjacent to a middle of a tailgate of the truck bed;
the driver side cover first cab side is substantially adjacent to a front end stake hole of the driver side panel and the driver side cover second cab side is substantially adjacent to a middle of a cab panel of the truck bed;
a length of passenger side cover is approximately equal to a length of a passenger side panel of the truck bed and a width of the passenger side cover is approximately equal to one half a length of the tail gate;
the passenger side cover first tailgate side is substantially adjacent to a back end stake hole of the passenger side panel and the passenger side second tailgate side is substantially adjacent to the middle of the tailgate; and
the passenger side cover first cab side is substantially adjacent to the front end stake hole of the driver side panel and the passenger side cover second cab side is substantially adjacent to the middle of the cab panel.

3. The truck bed covering and sidewall system of claim 1 wherein the retainer comprises:
a first cable having a first cable connector and a first cable cover fastener;
a second cable having a second cable connector and a second cable fastener;
a cable fastener;
a cover fastener;
a panel fastener, wherein:
the first cable is attached to the passenger side cover via the first cable cover fastener and is attached to the second cable via the second cable fastener;
the second cable is attached to the driver side cover via a second cable cover fastener and is attached to the second cable via the first cable fastener; and
the cable fastener is placed substantially between, and connects, the first able and second cable via the first cable cover fastener and the second cable cover fastener, respectively.

4. The truck bed covering and sidewall system of claim 3, wherein the first cable is attached to the passenger side cover and the second cable is attached to a cab panel of the truck bed.

5. The truck bed covering and sidewall system of claim 3, wherein the first cable is attached to the driver side cover and the second cable is attached to a cab panel of the truck bed.

6. The truck bed covering and sidewall system of claim 1, wherein the adjustable bar further comprises a pivoter and wherein the pivoter is removably attached to one of the two covers and wherein the adjustable bar is operable to inwardly folded along and parallely adjacent to, the underside of one of the two covers.

7. The truck bed covering and sidewall system of claim 6 wherein:
the adjustable bar is removably attachable to the driver side cover via a driver side clip; or
the adjustable bar is removably attachable to the passenger side cover via a passenger side clip.

8. The truck bed covering and sidewall system of claim 1, further comprising a stake hole assembly, the stake hole assembly comprising a block having a top, a bottom, a front, and a back, the block further comprising:
a platform attached to the top of the block;
a channel having an aperture, the channel being located on the front of the block;
a hinge affixed to the platform; and
a plate having a peg and a bracket, wherein the plate is slidably received by the channel and wherein the peg is removably inserted into the aperture.

9. The truck bed covering and sidewall system of claim 8, wherein:
a length, a width, and a height of the block are less than or equal to the length, width, and height of a stake hole;
the length and the width of the platform is greater than the length and width of the stake hole; and
when the block is removably inserted into the stake hole, the plate rests over the stake hole, a lip of the block is flush with a side panel of the truck bed, and the block is secured by inserting the peg through the aperture.

10. The truck bed covering and sidewall system of claim 8, wherein the attachment assembly is pivotally coupled to the driver side cover or the passenger side cover via the hinge.

11. The truck bed covering and sidewall system of claim 1, wherein the top fastener of the gas charged lift support is attached to the underside of one of the two covers and the bottom fastener of the gas charged lift support is attached to a stake hole assembly.

12. The truck bed covering and sidewall system of claim 8, wherein when the two covers are in a closed position:
the driver side cover and the passenger side cover are double doors; an
the driver side cover is substantially perpendicular to a driver side panel of the truck bed and the hinge is at a substantially 180 degree angle relative to the driver side cover;
the passenger side cover is substantially perpendicular to a passenger side panel of the truck bed and the hinge is at a substantially 180 degree angle relative to the passenger side cover;
the driver side cover and the passenger side cover are vertically folded over the truck bed and wherein the driver side cover second tailgate side and the passenger side second tailgate side are touching and are located substantially over a middle of a tailgate of the truck be; and
the adjustable bar is inwardly folded via a pivoter to be parallel to at least one of the two covers and the adjustable bar rests against the underside of at least one of the two covers.

13. The truck bed covering and sidewall system of claim 1, further comprising an open position, wherein:
the driver side cover and the passenger side cover function as sidewalls;
the driver side cover is substantially parallel to a driver side panel of the truck bed and a first hinge is at a substantially 90 degree angle relative to the driver side cover;
the passenger side cover is substantially parallel to a passenger side panel of the truck bed and a second hinge is at a substantially 90 degree angle relative to the passenger side cover;
the driver side cover second tailgate side and the second cab side extend substantially above the driver side panel;
the passenger side cover second tailgate side and the second cab side extend substantially above the passenger side panel; and
the adjustable bar is perpendicular to, and positioned between the underside of the passenger side cover and the underside of the driver side cover.

14. The truck bed covering and sidewall system of claim 1, wherein the seal further comprises a water repelling structure configured to removably attach to a seam between driver side cover and passenger side cover.

15. The truck bed covering and sidewall system of claim 1, further comprising a locking mechanism affixed substantially between a top of driver side panel and a top passenger side panel when the two covers are in a closed position.

16. (canceled)

17. (canceled)

18. (canceled)

19. (canceled)

20. (canceled)
